(19) United States
(12) Patent Application Publication
(10) Pub. No.: US 2011/0115373 A1
(43) Pub. Date: May 19, 2011

(54) MODULAR LED LIGHTING DEVICE

(76) Inventors: Eran Plonski, Montreal (CA); Sharath Kumar, Laval (CA); Eihab Baqui, Brossard (CA)

(21) Appl. No.: 12/818,324

(22) Filed: Jun. 18, 2010

Related U.S. Application Data
(63) Continuation of application No. PCT/CA2008/002230, filed on Dec. 19, 2008.
(60) Provisional application No. 61/015,056, filed on Dec. 19, 2007.

(51) Int. Cl. H01J 13/46; F21S 4/00; F21V 5/00

(52) U.S. Cl. 315/35; 362/249.02; 362/235

(57) ABSTRACT

There is described an LED lighting device comprising: a heat dissipating device having a planar surface; and a circuit board removably attached to the heat dissipating device and having a top surface, a bottom surface, and a surrounding side surface, the circuit board comprising at least one LED on the top surface and having at least one electrical connector on one of the top surface and the side surface for removably connecting the at least one LED to a power source, the bottom surface being abutted against the planar surface in order to transfer heat generated by the at least one LED to the heat dissipating device.

### CROSS-REFERENCE TO RELATED APPLICATIONS

The present application is a continuation under 35 USC §120 of International patent application no. PCT/CA2008/002230 filed Dec. 19, 2008 entitled MODULAR LED LIGHTING DEVICE, which claims priority under 35 USC§119(e) of Provisional Patent Application bearing Ser. No. 61/015,056, filed on Dec. 19, 2007 entitled MODULAR LED-BASED LIGHTING SYSTEM, the contents of which are hereby incorporated by reference.

### TECHNICAL FIELD

The present invention relates to the field of LED-based lighting systems.

### BACKGROUND

Light-emitting diodes (LEDs) are presently used in lighting systems in replacement of conventional lighting technologies such as gas discharge lamps, incandescent bulbs, halogen lamps, and fluorescent lighting systems.

LEDs present numerous advantages over conventional lighting technologies such as longer lifetime, higher efficiency, lower energy consumption and the possibility of controlling the brightness and the color of the emitted light.

When the LEDs of an LED-based lighting system have reached the end of their lifetime, the entire module has to be replaced or sent back to the manufacturer. This results in an increased cost of replacement. Therefore, there is a need for providing an LED-based lighting system which facilitates the replacement of LEDS and thus reduces their cost of replacement.

### SUMMARY

According to a broad aspect, there is provided an LED lighting device comprising: a heat dissipating device having a planar surface; and a circuit board removably attached to the heat dissipating device and having a top surface, a bottom surface, and a surrounding side surface, the circuit board comprising at least one LED on the top surface and having at least one electrical connector on one of the top surface and the side surface for removably connecting the at least one LED to a power source, the bottom surface being abutted against the planar surface in order to transfer heat generated by the at least one LED to the heat dissipating device.

### BRIEF DESCRIPTION OF THE DRAWINGS

Further features and advantages of the present invention will become apparent from the following detailed description, taken in combination with the appended drawings, in which:

FIG. 1 illustrates an exploded view of a modular LED lighting device according to an embodiment;

FIG. 2 illustrates a removable circuit board having a plug-in connector thereon according to an embodiment;

FIG. 3 illustrates a removable circuit board with a cable connected thereto in accordance with an embodiment;

FIG. 4 is a top view of an LED board provided with a pair of U-shaped electrical connectors, in accordance with an embodiment;

FIGS. 5a and 5b illustrate the U-shaped electrical connector of the LED board of FIG. 4 and an L-shaped electrical connector in an open state and a closed state, respectively, in accordance with an embodiment;

FIG. 6 is a top view of an LED board provided with a single U-shaped electrical connectors, in accordance with an embodiment;

FIGS. 7a and 7b illustrate a U-shaped electrical connector of the LED board of FIG. 6 and an L-shaped electrical connector in an open state and a closed state, respectively, in accordance with an embodiment;

FIG. 8 is a top view of an LED circuit board comprising a pair of hook electrical connectors, in accordance with an embodiment;

FIGS. 9a and 9b illustrate a pair of hook connectors in an open state and a closed state, respectively, in accordance with an embodiment;

FIG. 10 is a top view of an LED board having flat electrical connectors on a top surface, in accordance with an embodiment;

FIGS. 11a and 11b are a front view of the LED board of FIG. 10 in an unconnected state and a connected state, respectively, in accordance with an embodiment;

FIG. 12 is a top view of an LED board comprising connectors on its side surface, in accordance with an embodiment;

FIG. 13 is a partial perspective view of the LED board of FIG. 12, in accordance with an embodiment;

FIG. 14 illustrates one embodiment of a cylindrical heat sink;

FIG. 15 illustrates one embodiment of a comb-array heat sink; and

FIG. 16 illustrates an exploded view of an LED lighting device according to one embodiment.

It will be noted that throughout the appended drawings, like features are identified by like reference numerals.

### DETAILED DESCRIPTION

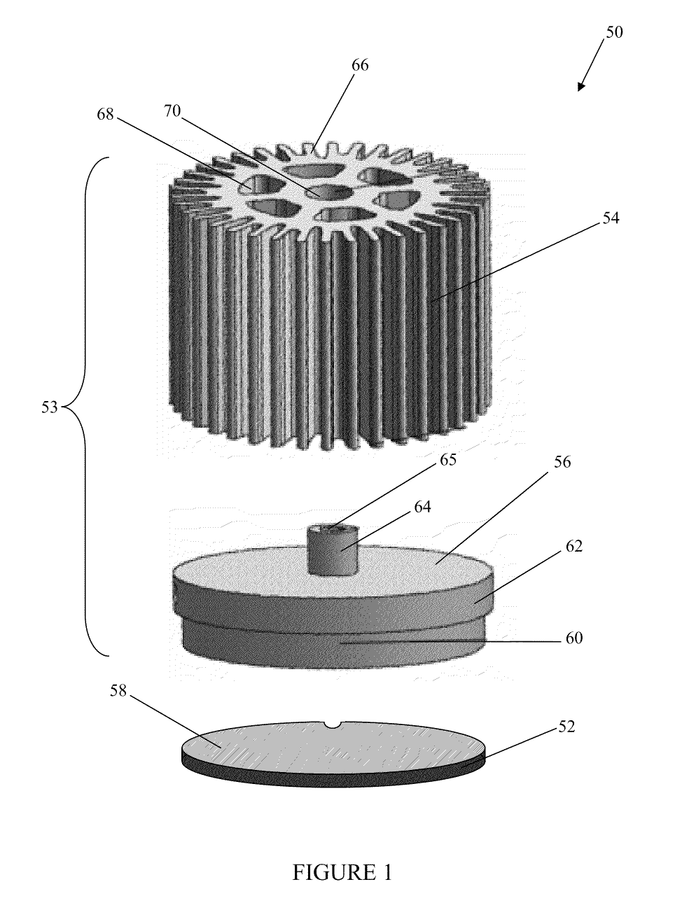

FIG. 1 illustrates an exploded view of an embodiment of an LED lighting device 50 comprising a removable circuit board 52 and a heat dissipating device 53 which includes a heat sink 54 and a plateau 56. The rear face 58 of the circuit board 52 is removably fixed onto a planar surface of the plateau 56 while the front face of the circuit board 52 comprises the LEDs (not shown). The circuit board is independent of the rest of the device so that it can be easily removed and replaced by another circuit board. Alternatively, the plateau may be omitted and the circuit board 52 is abutted against a planar surface of the heat sink 54.

The heat dissipating device 53 illustrated in FIG. 1 includes a heat sink 54 independent of the plateau 56. A heat dissipating device is used because LEDs are dependent on their surrounding temperature for brightness performances. An increase in the electrical current applied to an LED results in an increase in the brightness of light emitted by the LED. However, this increase in brightness is accompanied with an increase in temperature of the LED and this increased temperature will shorten the lifetime of the LED and decrease its brightness. As a result, cooling the LED ensures a long lifetime and a high brightness.

In the embodiment illustrated in FIG. 1, the plateau 56 is a cylindrical block with a flange 62 and a protrusion 64. An aperture 65 extends through the plateau 56. The circumference of the flange 62 substantially corresponds to that of the heat sink 54. The core 60 of the plateau 56 has a circumference which substantially corresponds to that of the circuit board 52. The protrusion 64 of the plateau 56 maintains the heat sink 54 in position on the plateau 56 by fitting into the aperture 70 provided therein. The role of the plateau 56 is to transfer the heat from the circuit board 52 to the heat sink 54 and to ensure a uniform repartition of the heat along the cross-section of the heat sink 54.

In the embodiment illustrated in FIG. 1, heat sink 54 is a cylinder having fins 66 on its outer lateral surface and apertures 68 which penetrate the heat sink in the direction of its height. Fins 66 and apertures 68 are used to increase the heat sink's 54 surface area contacting the air, and thus increase the heat dissipation rate. Heat sink 54 is further provided with an aperture 70 which also increases the heat dissipation rate in addition to mounting the heat sink 54 to the plateau 56.

In order to be removable, the circuit board 52 is removably connected to a power source. FIGS. 2-11 illustrate different electrical connecting means which allow the circuit board 52 to be removably connected to the power source.

In prior art lighting modules, the circuit board connector is located on an opposite side of an LED board from the LEDs. A recess or a hole is needed on the heat sink and/or an additional structure is provided below the LED board to allow room for the connector below the board. If the heat sink is provided with a recess or a hole, the connector fits into the recess or the hole when the LED board is attached to the heat dissipating structure. If there is no hole or recess in the heat sink, an additional structure, such as risers, is required to fix the board to the heat sink and to bring the heat generated by the LEDs to the heat sink, as well as to provide room for the connector between the heat sink and the underside of the board. This results in increased machining and costs. The problem generated by the connector located below the LED board prevents any interchangeability between boards and other components of the light since the LED board and the heat sink must be compatible.

FIG. 2 illustrates an embodiment of the removable circuit board 52. The circuit board 52 is a substrate on which electrical conductive elements 102 are deposited to electrically connect the LEDs 104 fixed thereon. The circuit board further includes a plug-in connector 106 to be removably connected to a power supply. A cable connected to a power source at one end and having a plug-in connector complementary to the plug-in connector 106 at the other end is used to removably connect the LEDs 104 to the power source by connecting the plug-in connector of this cable and the plug-in connector 106.

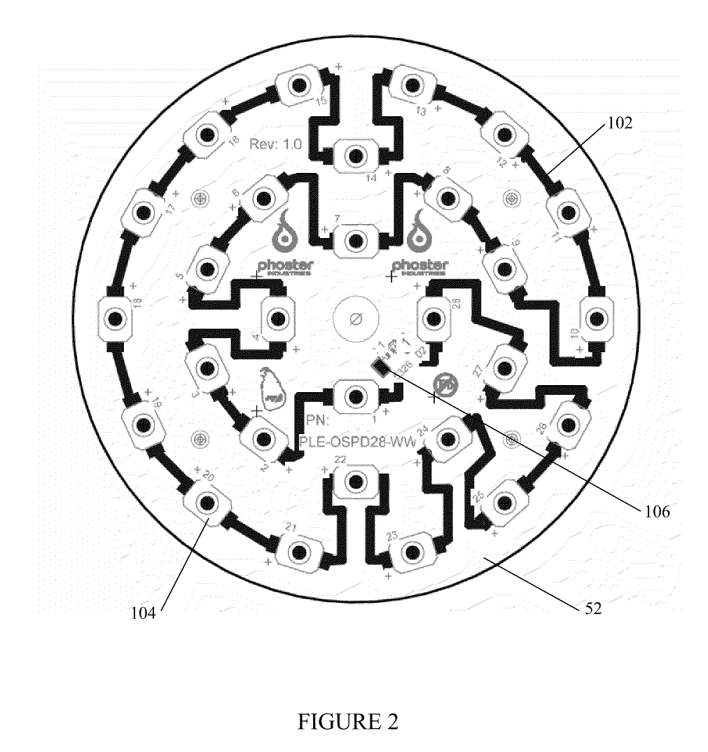

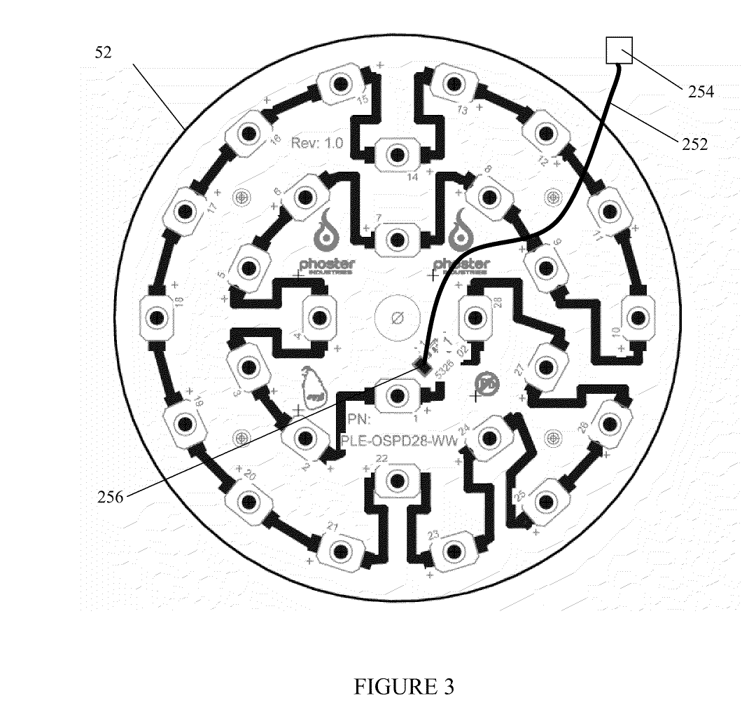

FIG. 3 illustrates another embodiment of the removable circuit board 52 which can be removably connected to a power supply by a cable 252. Cable 252 comprises a plug-in connector 254 which is connectable to a second plug-in connector linked to the power supply. Cable 252 is connected to electrical contact 256 of the circuit board 52. If the LEDs have reached the end of their lifetime or if the circuit board is deficient, the circuit board can easily be disconnected from the power supply and replaced by another one.

As shown in FIG. 3, the plug-in connector 106 or the cable 252 comprising the plug-in connector 254 are attached to the top of the removable circuit board 52 where the LEDs reside. Thus, the removable circuit board 52 can be removably fixed onto the plateau 56 or the heat sink 54 without requiring any hole therein or additional structure. A same removable circuit board 52 can be used with different heat sinks or plateaus without requiring any modifications to the heat sinks and plateaus, and without the need for additional fixing structures.

In one embodiment, the circuit board 52 has a notch on its side surface and the additional cable connecting the connector 106 to the power source, or the cable 252, passes through the notch, the aperture 65 of the plateau 62, and the aperture 70 of the heat sink 54 in order to be connected to the power source. If the heat dissipating device 53 comprises no plateau 56, the cable only passes in the aperture 70 of the heat sink 54.

Additionally, the plug-in connector 106 allows the use of the LED lighting device 50 in vibrating environments such as elevators. The plug-in connector 106 or 254 reduces the risk of being disconnected because of vibrations. The plug-in connector 106 or 254 allows a permanent but removable connection to a power supply. The term “permanent” is used to point out that once the plug-in connector is connected to the power supply, it is substantially impossible to disconnect it without a human intervention.

The use of a plug-in connector 106 or 254 renders the removable circuit board 52 completely independent from the rest of the LED lighting device 50. A male or female plug-in connector 106 is on the removable circuit board 52 and the other plug-in connector is connected to a power supply independently of the rest of the LED lighting device 50. The removable circuit board 52 does not need to be in electrical contact with another piece of the LED lighting device 50 in order to create an electrical contact between the connectors and to supply the LEDs with electricity.

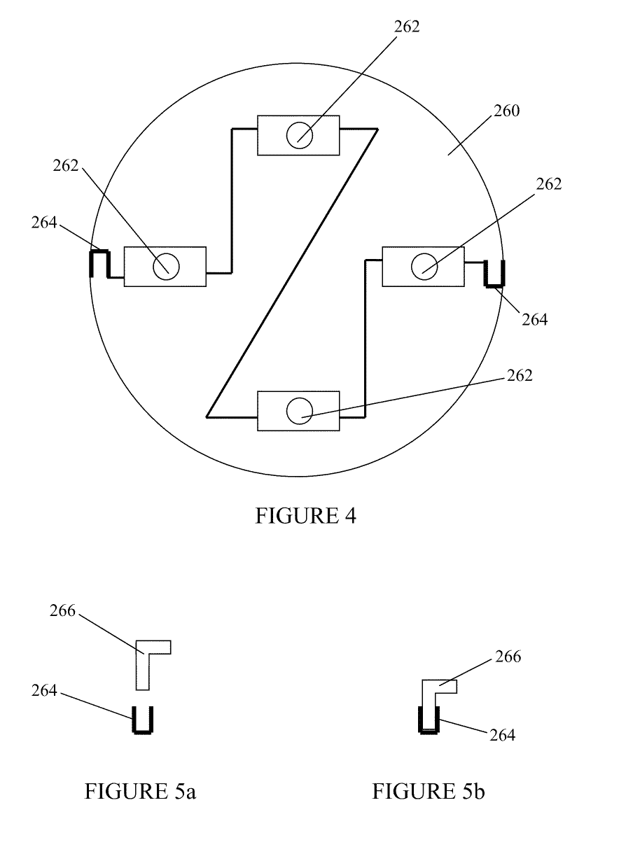

FIG. 4 illustrates a circuit board comprising four LEDs 262 connected in series and two U-shaped connectors 264. As illustrated in FIGS. 5a and 5b, the U-shaped connectors 264 are used with L-shaped connectors 266 and are attached to the frame of the lighting device and connected to the power source. The circuit board 260 is deposited on the heat dissipating device 53 and turned such that each U-shaped connector 264 engages a corresponding L-shaped connector 266 as illustrated in FIGS. 5a and 5b. The circuit board 260 can also be screwed to the heat dissipating device 53 to avoid any disconnection of the connectors 264 and 266.

It should be understood that the L-shaped connectors 266 can be replaced by any connectors mating the U-shaped connectors 264 as along as the LEDs 262 can be powered.

While in FIGS. 4 and 5a-b, the U-shaped connectors 264 are located on the circuit board 260 and the L-shaped connectors 266 are located on the frame of the lighting device 50, a person skilled in the art will understand that the L-shaped connectors could be positioned on the circuit board and the U-shaped connectors could be attached to the frame of the lighting device.

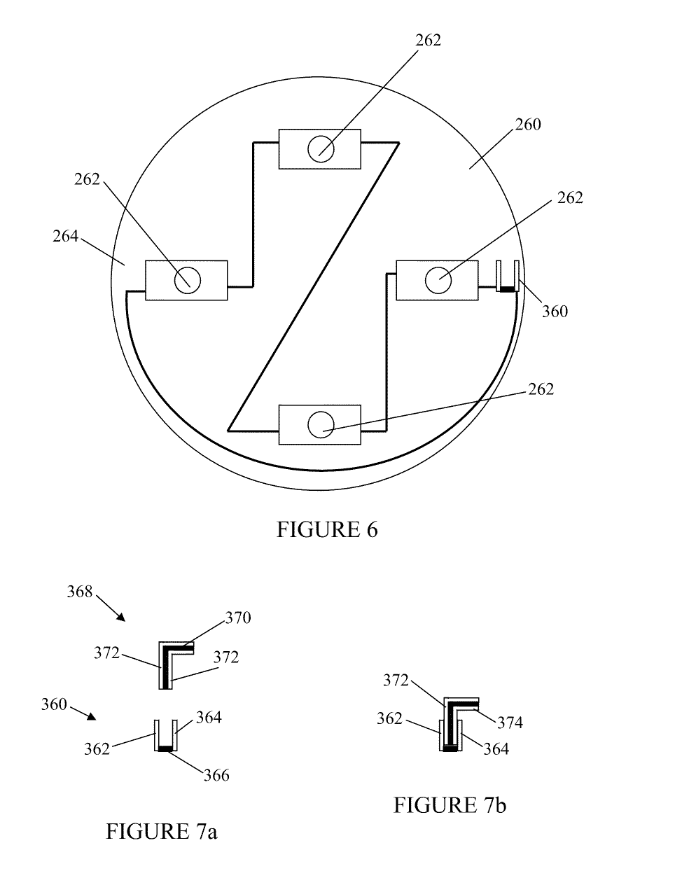

The circuit board 260 may comprise a single U-shaped connector 360 as illustrated in FIGS. 6 and 7a-b. The U-shaped connector 360 comprises two legs 362 and 364 made of electrically conductive material which are separated by an electrically insulating plate 366 forming the base of the U-shaped connector 360. The leg 362 is connected to a first one of the series of LEDs 262 while the leg 364 is connected to the last one of the LEDs 264. The circuit board 260 is deposited on the heat dissipating device 53 and turned such that the U-shaped connector 360 engages a corresponding L-shaped connector 368. The L-shaped connector 368 is positioned on the frame of the LED lighting device and comprises an electrically insulating L-shaped plate 370 sandwiched between two electrically conductive L-shaped plates 372 and 374. When the connectors are in a closed state, the legs 362 and 364 of the U-shaped connector 360 are in electrical contact with the L-shaped plates 372 and 374, respectively, in order to power the LEDs 262. It should be understood that the L-shaped connector 368 can be positioned on the LED board 262 while the U-shaped connector 360 is positioned on the frame of the LED lighting device.

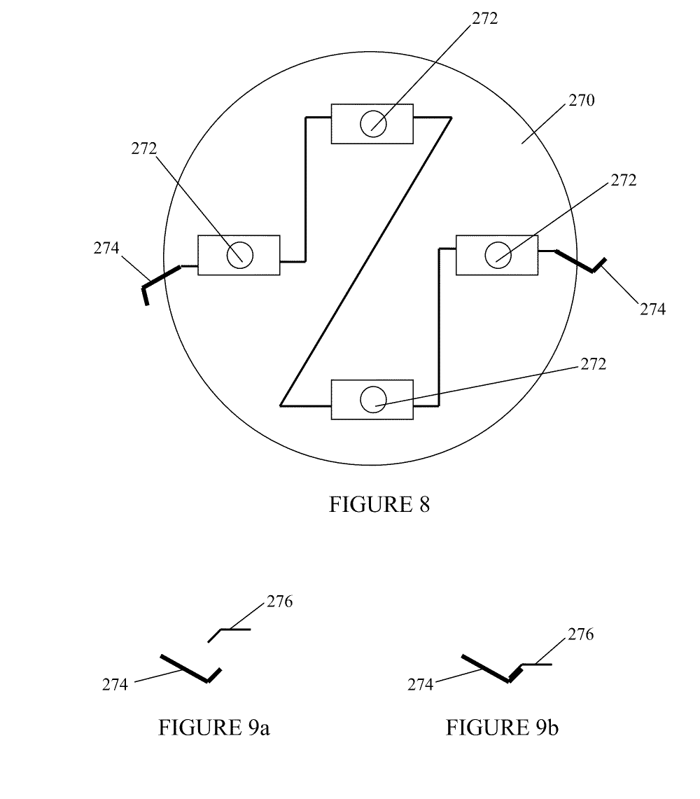

FIG. 8 illustrates a circuit board 270 comprising four LEDs 272 connected in series to a power source via a pair of hook connectors 274. As illustrated in FIGS. 9a and 9b, hook connectors 276 located on the frame of the lighting device and connected to the power source are used with the hook connectors 274 to connect the LEDs 272 to the power source. The circuit board 270 is deposited on the heat dissipating device 53 and turned such that each hook connector 276 engages a corresponding circuit board hook connector 274 in a turn-and-lock type mechanism as illustrated in FIG. 9b.

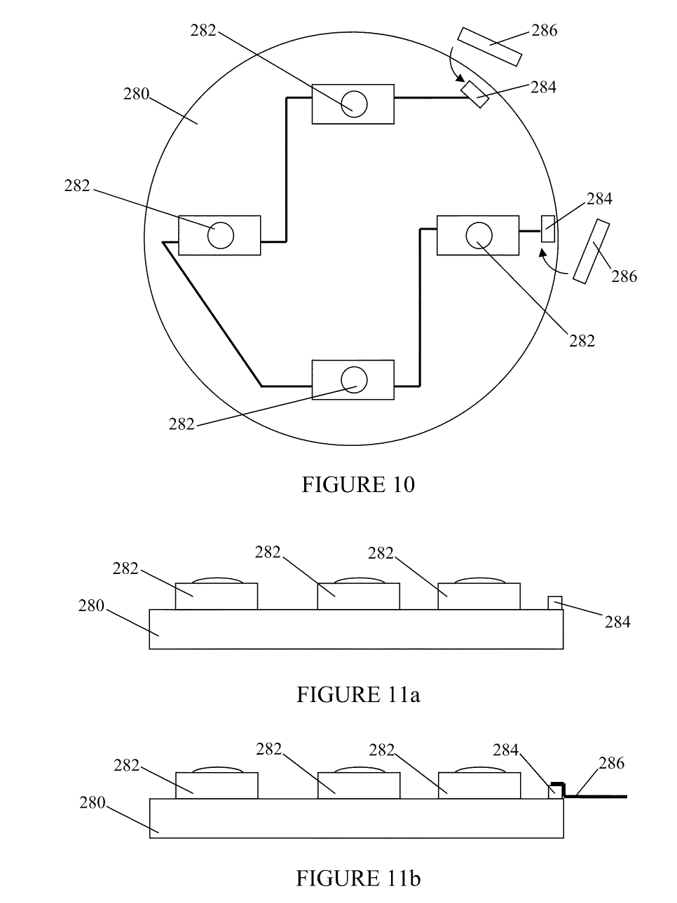

FIG. 10 illustrates an LED circuit board 280 comprising four LEDs 282 connected in series to a power source via a pair of plate connectors 284. A plate connector 284 is a plate of electrically conductive material. The plate connectors are positioned on the top surface of the circuit board 280, as illustrated in FIG. 11a. The frame of the lighting device surrounding the circuit board is provided with a pair of pivoting connectors 286 which are connected to the power source. Each pivoting connector 286 has a shape adapted to engage the plate connector 284. The pivoting connectors can be removably attached to the frame of the lighting device or they can be fixedly attached thereon while being pivotable. The circuit board 280 is positioned on top of the heat dissipating device and the pivoting connectors 286 are pivoted so that each pivoting connector engages a corresponding plate connector 284, as illustrated in FIGS. 10 and 11b. In addition to electrically connecting the LEDs 282 to the power source, the pivoting connectors 286 also maintain the circuit board 280 into position against the heat dissipating device 53.

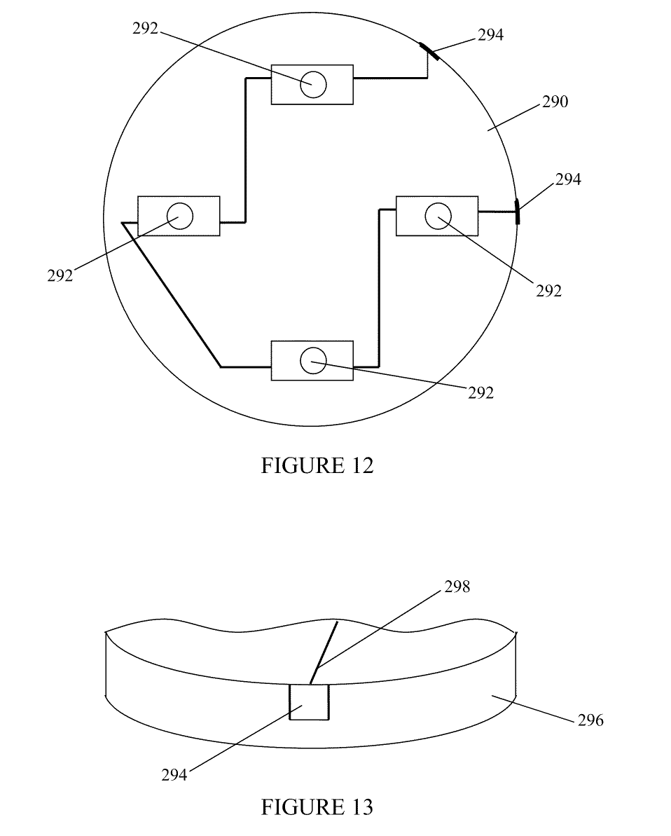

FIG. 12 illustrates an LED circuit board 290 comprising four LEDs 292 connected in series to a power source via a pair of plate connectors 294 located on a side surface 296 of the circuit board 290. As illustrated in FIG. 13, each plate connector 294 is located on the side surface of connected to an LED 292 via a connection line 298. The frame of the lighting device is provided with two electrical connectors (not shown) connected to the power source. These two frame connectors are positioned on the frame such that they are in electrical contact with the circuit connectors 294 when the circuit board is positioned on top of the heat dissipating device 53. The frame connectors can have any shape adapted to create an electrical contact with the connectors 294.

Using at least one connector on either the top surface of the LED circuit board or on its side surface allows the circuit board to be removably fixed onto the heat dissipating device 53 without requiring any hole therein or additional structure. A same removable circuit board can be used with different heat sinks or plateaus without requiring any modifications to the heat sinks and plateaus, and without the need for additional fixing structures.

In one embodiment, the connectors illustrated in FIGS. 6-13 are connected to the power source via at least one electrical cable which passes through a notch on the side surface of the LED board, the aperture 65 of the plateau 56, and the aperture 70 of the heat sink.

In one embodiment, the LED lighting device comprises no additional frame since the heat sink acts as the frame. The heat sink is designed to have a recess in which the LED board is inserted. In this case, the heat sink acts as a frame for maintaining in position the LED board and the connectors 266, 368, 286, and the frame connector corresponding to the connector 294 is located in the recess of the heat sink.

In one embodiment, the LED lighting device further comprises any electronic module or circuit such as a driver for converting the voltage delivered by the power source, for example, and the electronic module is connected to the power source via an electrical connector, for example. In this embodiment, the LED board is removably connected to the electronic module via any one of the electrical connections illustrated in FIGS. 3-13. Alternatively, the electronic module can be located outside of the LED lighting device.

While the plate connectors 284 and 294 have a rectangular shape, it should be understood that they can have any shape such as a circular shape, for example. The plate connectors can also have a non-planar shape such as a ball shape.

It should be understood that any electrical connector(s) which can be positioned either on the top surface or the side surface of a circuit board in order to removably connect the LEDs to a power source can be used. For example, any sliding connectors can be used.

In one embodiment, the circuit board may be provided with a thermally conductive layer on the opposite side of the board on which the LEDs reside. An example of a thermally conductive layer can be a layer of graphite. Copper can also be used for the thermally conductive layer. This embodiment may include a plateau 56 as illustrated in FIG. 1, or may omit the plateau as the thermally conductive layer can dissipate the heat in the horizontal direction.

In one embodiment, a heat conductive plate is inserted between the plateau 56 and the heat sink 54. This heat conductive plate is made of a material having a high thermal conductivity, such as copper or graphite, for example. This additional heat conductive plate is used to transfer the heat generated by the LEDs form the plateau 56 to the heat sink 54. Because of its high thermal conductivity, the heat conductive plate also evenly distributes the heat along the top surface of the heat sink 54.

In one embodiment, the circuit board may be removably fixed to the plateau by means of screws. A thermal paste may be used in addition to or in replacement of the screws. Alternatively, the circuit board can be maintained in position by the assembly of the different pieces or by an enclosure.

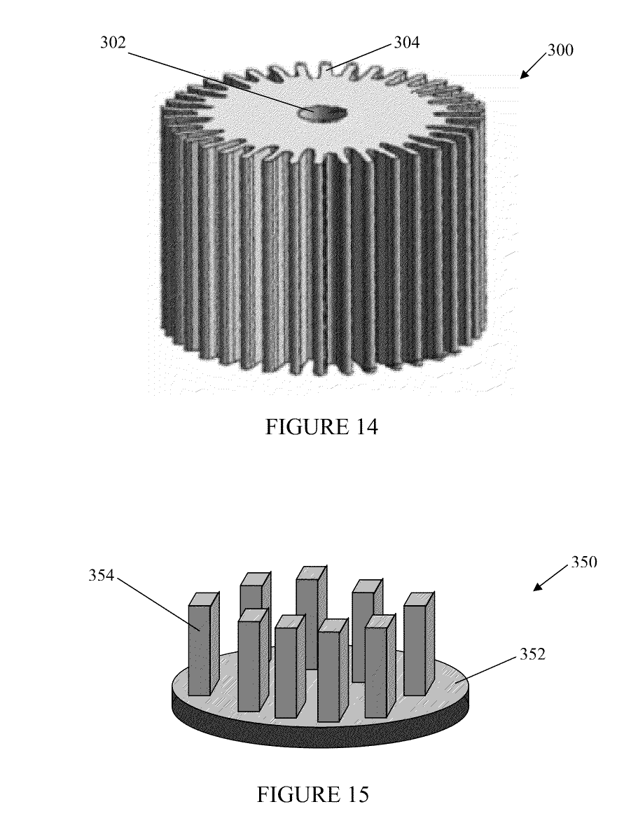

FIG. 14 illustrates another embodiment of the heat sink 54 that can be used for the LED based lighting device. Heat sink 300 is cylindrical and has fins 304 on its outer lateral surface and only one central aperture 302 to be removably fixed to the plateau.

FIG. 15 illustrates a comb-array heat sink having vertical fins. The heat sink 350 is made of a plate cylinder 352 provided with vertical fins 354 on its top side.

In one embodiment, the plateau 56 is only constituted of a cylindrical block that omits flange 62 and protrusion 64. The heat sink and the plateau may be maintained in position by way of the assembly of all the pieces constituting the LED based lighting module or by an enclosure. The plateau can be made of any material offering an enhanced thermal conductivity such as graphite or copper. Any material having good thermal conductivity may be used.

In one embodiment, the heat sink and the plateau constituting the heat dissipating device are permanently fixed to each other. The heat sink and the plateau may be made of one single piece. Alternatively, they can be permanently fixed by way of soldering, for example. Also alternatively, the heat sink and the plateau are independent pieces held together by pressure.

In another embodiment, the heat dissipating device only includes a heat sink on which the circuit board is removably affixed. Various configurations for the heat sink can be used, including but not limited to heat sink 54, 300 or 350. The circuit board may be removably affixed to the heat sink by screws or attached by other means. The width and the length of the heat sink 54, 300 or 350 and the plateau 62 may be varied as a function of the heat emission characteristics and the number of LEDS affixed to the circuit board 52.

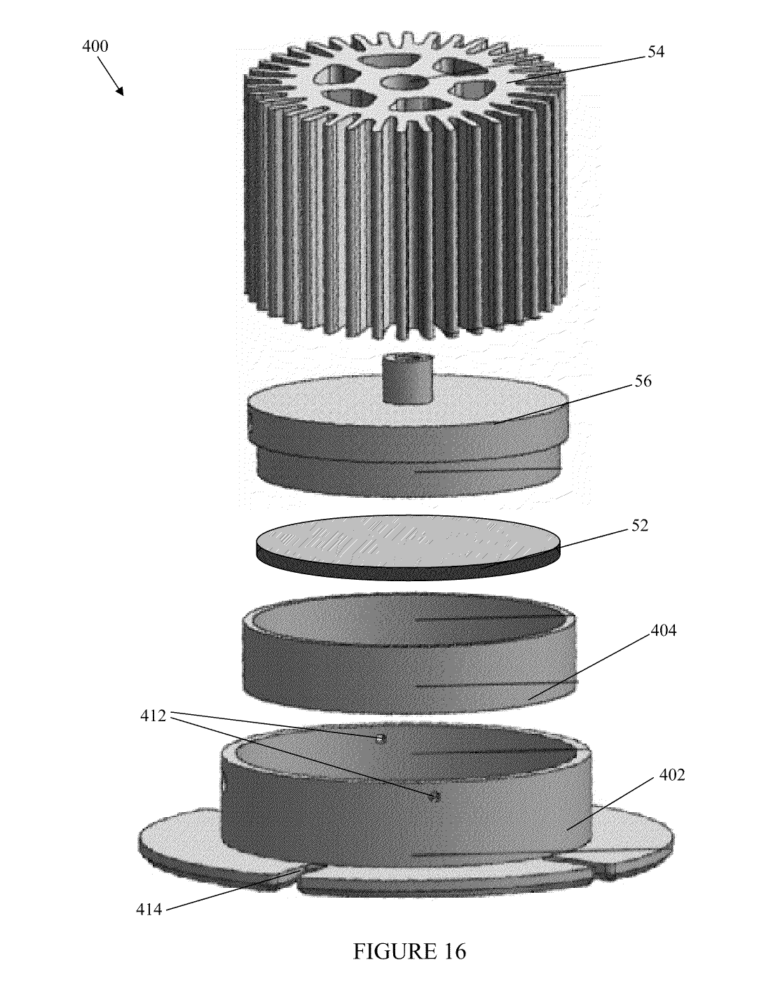

FIG. 16 illustrates an exploded view of an LED based lighting module according to one embodiment of the present invention. The LED based lighting module 400 comprises a housing 402, a holding ring 404, a circuit board 52 on which reside the LEDs, a plateau 56 and a heat sink 54. These pieces are stacked together and they are maintained in position by screws in holes 412. The housing 402 comprises a window (not shown) which can be made of glass or any transparent plastic material. The holding ring 404 is used to center the circuit board in the middle of the window. Slots 414 are provided on the housing 402 such that the LED based lighting module 400 may be fixed to a ceiling for example.

In one embodiment, the LED based lighting module 400 comprises a lens positioned on top of the circuit board in order to mix light emitted by the different LEDs positioned on the circuit board 52. The LED based lighting module 400 can further comprise a top threaded cap positioned on top of the lens and attached to the frame 402. This top threaded cap provides a pressure seal in order to maintain in position all of the elements of the LED based lighting module 400. While the present top cap is provided with a thread and screwed in order to be attached to the remaining of the LED based lighting module 400, it should be understood that any mechanical means for securely and removably attaching the top cap to the rest of the LED based lighting module 400 can be used.

While the present description refers to circular circuit board 52, it should be understood that the circuit board can have any shape. For example, the circuit board can be square, rectangular, etc.

It should be understood that any heat sink known to a person skilled in the art and suitable for an LED lighting device may be used. It should also be noted that the circuit board, the heat sink and the plateau can have any size and/or shape. While the illustrated examples of these pieces are cylindrical, they may be square, for example. The surfaces of the circuit board, the plateau and the heat sink in contact with each other may be provided with substantially the same surface area. Alternatively, the surface areas may differ. For example, the circuit board may be provided with a smaller surface area than that of the plateau, and the plateau may be provided with a smaller surface area than that of the heat sink.

The embodiments of the invention described above are intended to be exemplary only. The scope of the invention is therefore intended to be limited solely by the scope of the appended claims.

1. An LED lighting device comprising:
a heat dissipating device having a planar surface; and
a circuit board removably attached to said heat dissipating device and having a top surface, a bottom surface, and a surrounding side surface, said circuit board comprising at least one LED on said top surface and having at least one electrical connector on one of said top surface and said side surface for removably connecting said at least one LED to a power source, said bottom surface being abutted against said planar surface in order to transfer heat generated by said at least one LED to said heat dissipating device.

2. The LED lighting device as claimed in claim 1, wherein said at least one electrical connector is a plug-in connector located on said top surface of circuit board.

3. The LED lighting device as claimed in claim 1, further comprising at least one mating connector connected to said power source and engaging said at least one electrical connector.

4. The LED lighting device as claimed in claim 3, wherein said at least one electrical connector is a U-shaped electrical connector on said top surface.

5. The LED lighting device as claimed in claim 3, wherein said at least one electrical connector is an L-shaped electrical connector on said top surface.

6. The LED lighting device as claimed in claim 3, wherein said at least one electrical connector is a pair of hook electrical connectors on said top surface.

7. The LED lighting device as claimed in claim 3, wherein said at least one electrical connector is a pair of plate electrical connectors on said top surface.

8. The LED lighting device as claimed in claim 3, wherein said at least one electrical connector is a pair of electrical plate connectors on said side surface.

9. The LED lighting system device as claimed in claim 4, wherein said at least one mating connector is positioned on said heat dissipating device.

10. The LED lighting device as claimed in claim 4, further comprising a frame for receiving said circuit board, said at least one mating connector being positioned on said frame.

11. The LED lighting device as claimed in claim 3, wherein said at least one mating connector is attached to a cable for removably connecting to said power source, said cable extending through said heat dissipating device.

12. The LED lighting device as claimed in claim 1, wherein said circuit board comprises a notch on said side surface to receive a cable having a mating connector engaged in said at least one electrical connector.

13. The LED lighting device as claimed in claim 1, wherein said heat dissipating device comprises a heat sink and a plateau, said plateau being positioned between said bottom surface of said circuit board and said heat sink, thereby uniformly repartitioning said heat generated by said at least one LED along a cross-section of said heat sink

14. (canceled)

15. The LED lighting device as claimed in claim 13, wherein said heat sink is removably attached to said plateau.

16. The LED lighting device as claimed in claim 13, wherein a heat conductive plate is located between said plateau and said circuit board.

17. (canceled)

18. The LED lighting device as claimed in claim 1, wherein said circuit board includes a heat conductive layer on said bottom surface.

19. The LED lighting device as claimed in claim 10, further comprising a lens positioned on top of said top surface of said circuit board.

20. The LED lighting system as claimed in claim 19, further comprising a top threaded cap positioned on top of said lens and attached to said frame.

21. The LED lighting system as claimed in claim 1, further comprising an embedded driver for converting a voltage delivered by said power source.

22. The LED lighting system as claimed in claim 13, further comprising a heat dissipating plate inserted between said plateau and said heat sink.
